(19) United States
(12) Patent Application Publication
(10) Pub. No.: US 2010/0181787 A1
(43) Pub. Date: Jul. 22, 2010

(54) Pet Waste Collection and Disposal Device

(76) Inventor: John R. Williamson, Bloomington, MN (US)

Correspondence Address: ROGER BELFAY ATTORNEY AT LAW, 829 TUSCARORA AVENUE, SAINT PAUL, MN, 55102, US

(21) Appl. No.: 12/690,823

(22) Filed: Jan. 20, 2010

Related U.S. Application Data
(60) Provisional application No. 61/205,484, filed on Jan. 21, 2009.

(51) Int. Cl. A01K 29/00

(52) U.S. Cl. 294/1.3

(57) ABSTRACT

The Pet Waste Collection and Disposal Device is a single use Pet Waste Collection and Disposal Device comprising, a handle, and a flexible formed collector. The handle may be formed of any material sufficiently rigid to force the formed collector into the open position shown. The flexible formed collector may be fabricated of paper, plastic, or any other material of sufficient durability to withstand the stresses of opening, closing, and carriage. The user transitions The Pet Waste Collection and Disposal Device from the closed to the open state by grasping the handle and contacting the ground, or other surface, with the leading edge. Upon contacting the ground or other surface the forward motion imparted by the user causes the handle to pivot in an arc causing the flexible formed collector to open.

### CROSS REFERENCE TO RELATED APPLICATIONS

The application listed below is the only application related to this application. This application claims benefit of the earlier filing date under 35 USC 119(e) of provisional application No. 61/105,484 filed on Jan. 21, 2009.

### STATEMENT REGARDING FEDERALLY SPONSORED RESEARCH OR DEVELOPMENT

No invention claimed in this application was made under Federally sponsored research or development.

### THE NAMES OF THE PARTIES TO A JOINT RESEARCH AGREEMENT

Not Applicable

### REFERENCE TO A SEQUENCE LISTING

Not Applicable

### BACKGROUND OF THE INVENTION

1. Field of the Invention

The present invention relates to hand held waste collection devices often used in building and grounds maintenance.

2. Description of Related Art

There are many devices found in the art which accomplish the purpose of collecting and disposing unpleasant waste products. U.S. Pat. Nos. 6,588,375 of Jul. 8, 2003 to Bennedittini, 6,554,334, of Apr. 29, 2003 to Uribe, 5,320,393, of Jun. 14, 1994, to Cortinas, 3,431,008 of Mar. 4, 1969 to Narita, 5,820,179, of Oct. 13, 1998 to Tsou, and 4,225,174, of Sep. 30, 1980 to Hennessy, all show waste collection devices of this type. In most cases it is an object of the invention to accomplish the removal and disposal of the waste without the user having to make physical contact with the waste. Minimizing the contact between user and waste is also an object of the present invention. The present invention achieves this objective by implementing a disposable waste collections and disposal unit.

### BRIEF SUMMARY OF THE INVENTION

The Pet Waste Collection and Disposal Device is a single use Pet Waste Collection and Disposal Device comprising, a handle, and a flexible formed collector. The handle may be formed of any material sufficiently rigid to force the formed collector into the open position shown in FIGS. 1 and 3. The flexible formed collector may be fabricated of paper, plastic, or any other material of sufficient durability to withstand the stresses of opening, closing, and carriage of waste material for disposal.

In use The Pet Waste Collection and Disposal Device operates in two states: Open and Closed. When Open, as shown in FIGS. 1 and 3, The Pet Waste Collection and Disposal Device is held by a user while the user moves The Pet Waste Collection and Disposal Device to capture pet, or other, waste for disposal. In the closed position, as shown in FIG. 2, The Pet Waste Collection and Disposal Device serves as a carrier for the pet, or other, waste collected by the user, or is just carried by the user in anticipation of collection of such waste.

The user transitions The Pet Waste Collection and Disposal Device from the closed to the open state by grasping the handle and contacting the ground, or other surface, with the leading edge. Upon contacting the ground or other surface the forward motion imparted by the user causes the handle to pivot in an arc causing the flexible formed collector to open as shown in FIGS. 1 and 3.

An advantage of the Pet Waste Collection and Disposal Device is that Pet waste or other unpleasant materials may be collected and disposed of without the user having to make contact with the material being disposed.

### BRIEF DESCRIPTION OF THE SEVERAL VIEWS OF THE DRAWING

FIG. 1 is a perspective view of the collection and disposal device in the open position during use.

FIG. 2 is a perspective view of the collection and disposal device in the closed position before and after use.

FIG. 3 is a perspective view of the collection and disposal device in the open position in use by a user.

### DETAILED DESCRIPTION OF THE INVENTION

The Pet Waste Collection and Disposal Device is a single use Pet Waste Collection and Disposal Device comprising, a handle 1, and a flexible formed collector 2.

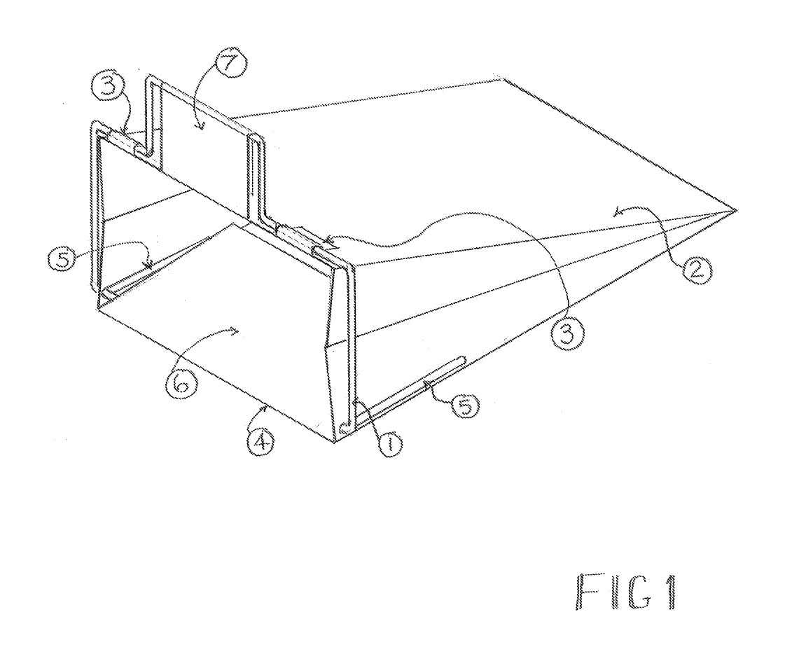

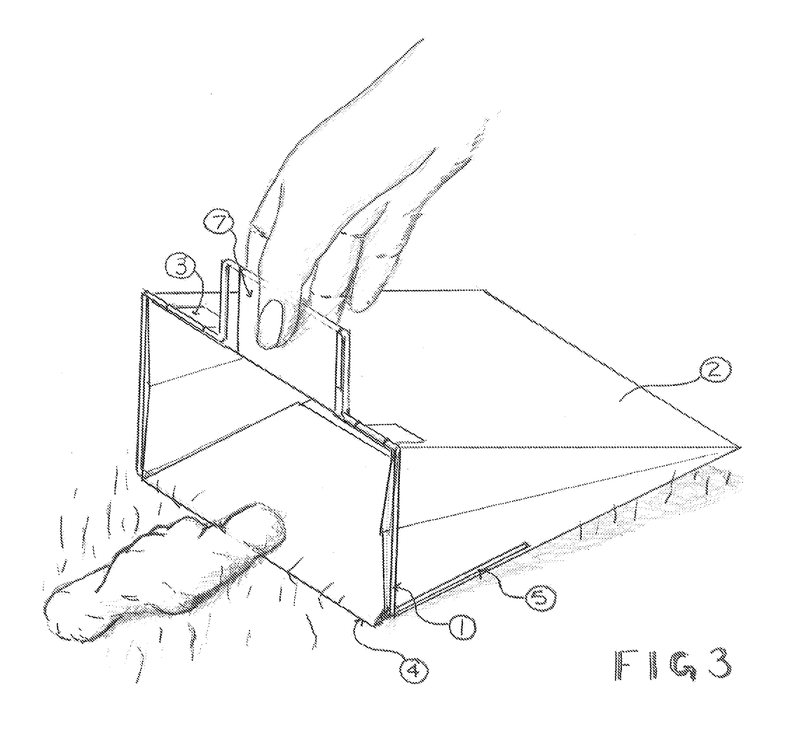

The handle 1 may be formed of any material sufficiently rigid to force the formed collector 2 into the open position shown in FIGS. 1 and 3. It is to be understood that, while the material selected for the handle 1 can be metal, or plastic, the handle 1 may be made from any material meeting the need for rigidity. While material selected for construction of the handle 1 is generally selected to meet cost and durability considerations imposed by the market place, it is understood that the handle 1 as defined herein is not dependant upon the selection materials.

The flexible formed collector 2 may be fabricated of paper, plastic, or any other material of sufficient durability to withstand the stresses of opening, closing, and carriage of waste material for disposal. It is to be understood that, while the material selected for the flexible formed collector 2 can be metal, plastic, the flexible formed collector 2 may be made from any material meeting the need for durability. While material selected for construction of the flexible formed collector 2 is generally selected to meet cost and durability considerations imposed by the market place, it is understood that the flexible formed collector 2 as defined herein is not dependant upon the selection materials.

The component shapes illustrated by the figures are illustrative and do not limit the variety of shapes of the opening in the flexible formed collector 2, other shape of the flexible formed collector 2, or Handle 1. Any shape of these components consistent with successful operation of the Pet Waste Collection and Disposal Device is considered to be within the scope of the present invention.

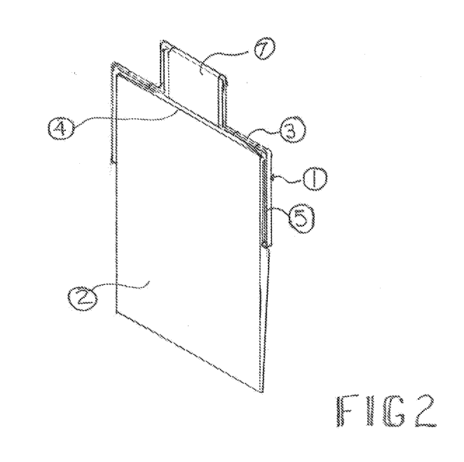

In use The Pet Waste Collection and Disposal Device operates in two states: Open and Closed. When Open, as shown in FIGS. 1 and 3, The Pet Waste Collection and Disposal Device is held by a user while the user moves The Pet Waste Collection and Disposal Device to capture pet, or other, waste for disposal. In the closed position, as shown in FIG. 2, The Pet Waste Collection and Disposal Device serves as a carrier for the pet, or other, waste collected by the user, or is just carried by the user in anticipation of collection of such waste. It is to be noted that The Pet Waste Collection and Disposal Device may contain collected waste and be used one or more subsequent times to collect additional waste.

The user transitions The Pet Waste Collection and Disposal Device from the closed to the open state by grasping the handle and contacting the ground, or other surface, with the leading edge 4. Upon contacting the ground or other surface the forward motion imparted by the user causes the handle 1 to pivot in an arc causing the flexible formed collector 2 to open as shown in FIGS. 1 and 3. It will be appreciated that, while the arc shown is approximately 90 degrees, such an arc is only typical. For successful operation, it is only necessary that the arc be sufficient to allow the waste to pass through the opening produced in the flexible formed collector 2. When the waste is captured within the flexible formed collector 2, the user raises the handle 1 and the opening in the flexible formed collector 2 closes and The Pet Waste Collection and Disposal Device is ready for another collection cycle, disposal, or storage.

The operation and durability of the Pet Waste Collection and Disposal Device may be enhanced by the addition of a hinge point in the form of a tab 3 or formed hinge 3. The tab 3, or formed hinge 3, forming the connection the handle to the container. The tab 3 or formed hinge 3 can be implemented as a tab 3 which is formed from a single piece of material along with the flexible formed collector 2, or formed from a separate piece and attached to the flexible formed collector 2 by and adhesive, or any other appropriate fastener.

The handle 1 of the Pet Waste Collection and Disposal Device may further comprise a flat ground contour portion 4 located at the bottom of the flexible formed collector 2 giving shape to an opening in the flexible formed collector 2.

The flexible formed collector 2 of the Pet Waste Collection and Disposal Device may further comprise a slot 5 into which the handle 1 connects. The slot 5 may also be implemented by a slide affixed to the flexible formed collector 2.

The flexible formed collector 2 of the Pet Waste Collection and Disposal Device may further comprise a slide into which the handle 1 slides.

The Pet Waste Collection and Disposal Device may further comprise a check tab 6 to facilitate operation and passage of the waste through the opening in the flexible formed collector 2.

I claim:

1) A single use Pet Waste Collection and Disposal Device comprising:
a) a handle; and
b) a flexible formed collector.

2) The Pet Waste Collection and Disposal Device of claim 1 further comprising:
a) a hinge point in the form of a tab or formed hinge, the hinge connecting the handle to the container.

3) The Pet Waste Collection and Disposal Device of claim 2 wherein the handle further comprises;
a flat ground contour portion the ground contour portion located at the bottom of the flexible formed collector giving shape to an opening in the flexible formed collector.

4) The Pet Waste Collection and Disposal Device of claim 2 wherein the handle provides the opening and closing operation of the flexible formed collector.

5) The Pet Waste Collection and Disposal Device of claim 2 wherein the flexible formed collector further comprises:
an open end.

6) The Pet Waste Collection and Disposal Device of claim 5 wherein the open end is attached to the handle.

7) The Pet Waste Collection and Disposal Device of claim 2 wherein the flexible formed collector further comprises a slot into which the handle 1 connects.

8) The Pet Waste Collection and Disposal Device of claim 2 wherein the flexible formed collector further comprises a slide into which the handle 1 slides.

9) The Pet Waste Collection and Disposal Device of claim 2 wherein the handle threads through one or more tabs and an upper tab.

10) The Pet Waste Collection and Disposal Device of claim 1 further comprising a check tab.

11) The Pet Waste Collection and Disposal Device of claim 1 further comprising an odor absorbent material.
